(19) United States
(12) Patent Application Publication
(10) Pub. No.: US 2025/0249564 A1
(43) Pub. Date: Aug. 7, 2025

(54) STRAIGHT-HANDLE VALVELESS PRESSURIZED PNEUMATIC SPADE

(71) Applicant: Ningbo Yinzhou Yongdun Pneumatic Tools Manufacturing Co., Ltd, Ningbo (CN)

(72) Inventor: Jinhao TANG, Ningbo (CN)

(73) Assignee: Ningbo Yinzhou Yongdun Pneumatic Tools Manufacturing Co., Ltd, Ningbo (CN)

(21) Appl. No.: 18/806,688

(22) Filed: Aug. 15, 2024

(30) Foreign Application Priority Data
Feb. 2, 2024 (CN) 202420259514.8

(51) Int. Cl. B25D 9/04; A01B 1/02; B25D 17/04

(52) U.S. Cl. CPC B25D 9/04; A01B 1/02; B25D 17/04; B25D 2250/051

(57) ABSTRACT

The disclosure discloses a straight-handle valveless pressurized pneumatic spade, including a handle, a coupling tube, a cylinder, a hammer, a front member, a spade head, and the like. The handle is mainly arranged to be composed of a switch sleeve mounted to an upper portion of the coupling tube and a handle body mounted to an upper portion of the switch sleeve. The switch sleeve, the handle body, the coupling tube, the cylinder, and the front member are all arranged on a same shaft axis to form a straight handle, and then an air intake switch in the handle body is configured to enable and disable communication between an air intake connector on the handle body and a connecting cavity in the switch sleeve. Apparently, such a straight handle has a simpler appearance, so as to facilitate assembling of the air intake switch, and a mounting structure is also more compact, thereby avoiding a risk of air leakage. In addition, the simple appearance reduces a packaging volume and facilitates transportation and storage. Moreover, through a plurality of slots provided on the outer circumferential surface, the upper end of the spade head is engaged with and operated by axially reciprocally moving up and down within the front member, which causes the spade head having such slots to be applicable to electric hammers, greatly expanding a range of application of the spade head.

### CROSS-REFERENCE TO RELATED APPLICATION

This application claims a priority to Chinese Patent Application No. 202420259514.8 filed on Feb. 2, 2024, which is incorporated herein by reference in its entirety.

### TECHNICAL FIELD

The disclosure relates to a pneumatic spade, and in particular, to a straight-handle valveless pressurized pneumatic spade.

### BACKGROUND

A pneumatic spade is a pneumatic impact tool for digging soil, digging trees, and digging ditches in an impact mode in gardening and agricultural tasks, which may further be used for tasks such as wall shoveling and floor shoveling in decoration tasks, or may be used for small-scale concrete breaking, foundation tamping, hole drilling, and perforation in municipal engineering, and may also be used for tasks such as sand removal of various castings and shoveling, cutting, and trimming of a surface of a metal material. Currently, a structure of the pneumatic spade is generally composed of a coupling tube, a handle mounted to an upper portion of the coupling tube, a cylinder mounted to a lower portion of the coupling tube, a front member mounted to a lower portion of the cylinder, a hammer arranged in the cylinder and the front member, and the like. An upper end of the hammer axially reciprocates and is hermetically inserted into the cylinder. A lower portion of the front member is provided with a spade head that is axially movable and inserted. Therefore, an impact operation may be implemented by striking the spade head by the hammer. The handle is usually designed to be in a complex T shape or a ring shape. Although the design has a specific aesthetic appearance, the design of air intake routes in the handle may be complex. Therefore, the assembly of an air intake switch in the handle is not convenient, and a relatively high risk of air leakage also exists. In addition, the complex handle appearance also brings inconvenience to packaging, and often occupies a relatively large packaging volume, which is not conducive to transportation and storage. Moreover, an upper end of the spade head used by the existing pneumatic spade is engaged with a ring groove having a relatively large width and operated by axially reciprocally moving up and down. Therefore, the spade head is not applicable to an electric hammer, resulting in a limitation on a range of application.

### SUMMARY

A technical problem to be resolved in the disclosure is to overcome defects of the prior art, and provide a straight-handle valveless pressurized pneumatic spade with a compact structure, a simple appearance, and an applicable spade head that can be applicable to an electric hammer.

The technical problem of the disclosure is resolved through the following technical solutions.

A straight-handle valveless pressurized pneumatic spade includes a coupling tube, a handle mounted to an upper portion of the coupling tube, a cylinder mounted to a lower portion of the coupling tube, and a front member mounted to a lower portion of the cylinder. A hammer is arranged inside the cylinder and the front member. An upper end of the hammer axially reciprocates and is hermetically inserted into the cylinder. A lower portion of the front member is provided with a spade head that is axially movable and inserted. The handle is composed of a switch sleeve mounted to the upper portion of the coupling tube and a handle body mounted to an upper portion of the switch sleeve. The switch sleeve, the handle body, the coupling tube, the cylinder, and the front member are all on a same shaft axis, so that the handle forms a straight handle. A connecting cavity is arranged in the switch sleeve. Atop portion of the handle body is provided with an air intake connector. An air intake switch is arranged in the handle body, and the air intake switch is configured to enable and disable communication between the air intake connector and the connecting cavity.

A horizontal hole, an inclined hole provided above the horizontal hole, and a vertical hole respectively in communication with the horizontal hole and the connecting cavity are provided in the handle body, and the air intake connector is hermetically inserted into the inclined hole and directly brought into communication with the horizontal hole.

The air intake switch includes a push rod movably and hermetically arranged in the horizontal hole. An outer end of the push rod is elastically pushed outward and extends out of the horizontal hole to contact a pressing handle. An inner end of the push rod is provided with a valve pad. The pressing handle presses the push rod to move inward, and drives the valve pad to open the horizontal hole, or the push rod is elastically pushed to move outward to its original position, and therefore drives the valve pad to close the horizontal hole.

An inner shoulder is arranged in a middle portion of the horizontal hole, and the horizontal hole is divided into a left hole and a right hole by the inner shoulder. The push rod is movably and hermetically arranged in the left hole. An inner end of the push rod extends into the right hole and is provided with the valve pad. A valve spring that elastically pushes the push rod outward is arranged in the right hole. The push rod moves axially inward and outward and drives the valve pad to be disengaged from the inner shoulder to open the horizontal hole or to contact the inner shoulder to close the horizontal hole.

An upper portion of the cylinder is provided with an air intake seat that is hermetically mounted. An upper cavity is formed in the cylinder between the air intake seat and the upper end of the hammer. A lower cavity is formed between an outer wall of the hammer and an inner wall of the cylinder. An air outlet cavity is formed between the hammer and the front member. A cylinder air channel in communication with the lower cavity is provided in the cylinder. An air inlet respectively in communication with an air intake cavity in the coupling tube and the cylinder air channel is provided on the air intake seat. A blind air outlet in communication with the upper cavity is provided in the hammer. A side of the hammer is provided with an air outlet in communication with the blind air outlet. The air outlet is brought into communication with the air outlet cavity or the lower cavity through the axial reciprocation of the hammer. A side of the front member is provided with a vent hole respectively in communication with the air outlet cavity and an external atmosphere.

An interconnecting coupling sleeve is arranged between the coupling tube and the cylinder, and an upper end of the front member is threadedly connected to a lower end of the cylinder.

An axial pass-through mounting hole is provided in the front member. A side of the front member is provided with a side hole in communication with the mounting hole. A ball-headed pin roller is arranged in the side hole. The lower portion of the front member is provided with an end sleeve that is movably sleeved. An inner wall of the end sleeve is provided with a protrusion and a recess. The end sleeve moves upward to drive the recess to exactly face the ball-headed pin roller. The ball-headed pin roller retracts into the side hole. An upper end of the spade head is inserted into the mounting hole or disengaged from the mounting hole. The end sleeve moves downward to drive the protrusion to push the ball-headed pin roller, and the ball-headed pin roller protrudes out of the side hole to lock the upper end of the spade head.

A plurality of evenly distributed circumferential slots are provided on an outer circumferential surface of the upper end of the spade head, and the ball-headed pin roller protrudes out of the side hole to be fitted into each of the slots to lock the upper end of the spade head.

The slots are waist-shaped slots extending in an axial direction, a length dimension of each of the slots needs to be greater than a diameter of the side hole, and the ball-headed pin roller needs to have a stroke for axially reciprocally moving up and down in the slot.

The lower portion of the front member is provided with an end sleeve compression spring that is sleeved. The end sleeve compression spring elastically pushes the end sleeve downward and then drives the protrusion to push the ball-headed pin roller, and a shaft retaining ring for fixing a lower end position of the end sleeve is arranged on the front member.

Compared with the prior art, in the disclosure, the handle is mainly designed to be composed of the switch sleeve mounted to the upper portion of the coupling tube and the handle body mounted to the upper portion of the switch sleeve. The switch sleeve, the handle body, the coupling tube, the cylinder, and the front member are all on the same shaft axis, so that the handle forms a straight handle. In addition, the connecting cavity is arranged in the switch sleeve, the top portion of the handle body is provided with the air intake connector, and the air intake switch is directly designed in the handle body, so as to enable and disable the communication between the air intake connector and the connecting cavity. Apparently, such a straight handle has a simpler appearance, so as to facilitate assembling of the air intake switch, and a mounting structure is also more compact, thereby avoiding a risk of air leakage. In addition, the simple appearance reduces a packaging volume and facilitates transportation and storage. Moreover, through the plurality of evenly distributed circumferential slots provided on the outer circumferential surface, the upper end of the spade head is engaged with and operated by axially reciprocally moving up and down within the front member, which causes the spade head having such slots to be applicable to electric hammers, greatly expanding a range of application of the spade head.

### BRIEF DESCRIPTION OF THE DRAWINGS

FIG. 1 is a schematic structural cross-sectional view of the disclosure.

FIG. 2 is an enlarged cross-sectional view of a handle part in FIG. 1.

FIG. 3 is a cross-sectional view of FIG. 2 with a pressing handle, a push rod, and a valve spring being removed.

FIG. 4 is a schematic structural diagram of a push rod.

FIG. 5 is an enlarged cross-sectional view of FIG. 1 with a handle part being removed.

FIG. 6 is an enlarged cross-sectional view of a front member.

FIG. 7 is an enlarged cross-sectional view of an end sleeve.

FIG. 8 is a schematic structural diagram of a spade head.

FIG. 9 is a left view of FIG. 8.

### DETAILED DESCRIPTION

Embodiments of the disclosure are described in detail again below with reference to the foregoing accompanying drawings.

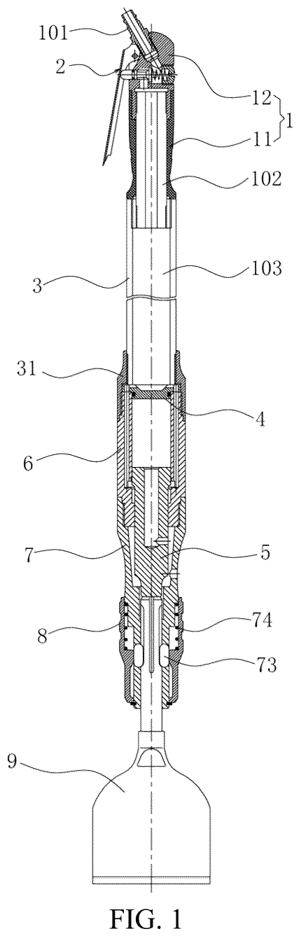

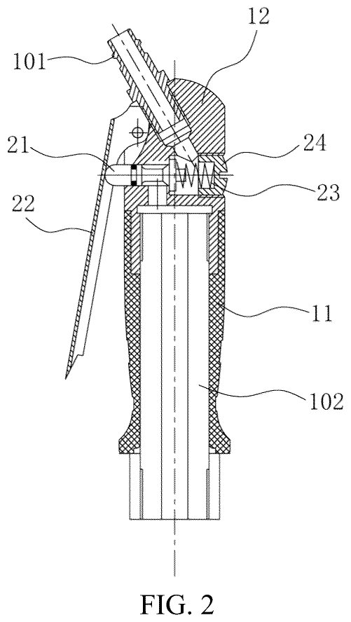

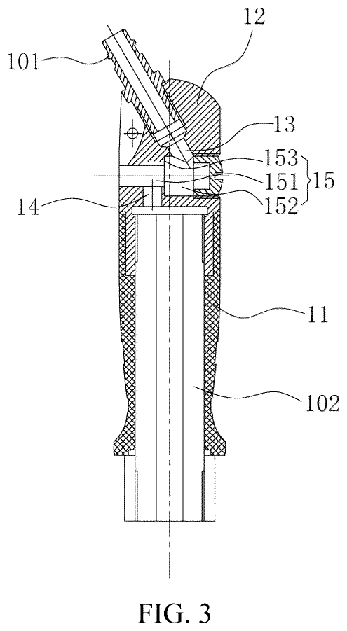

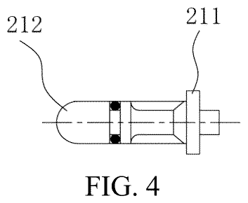

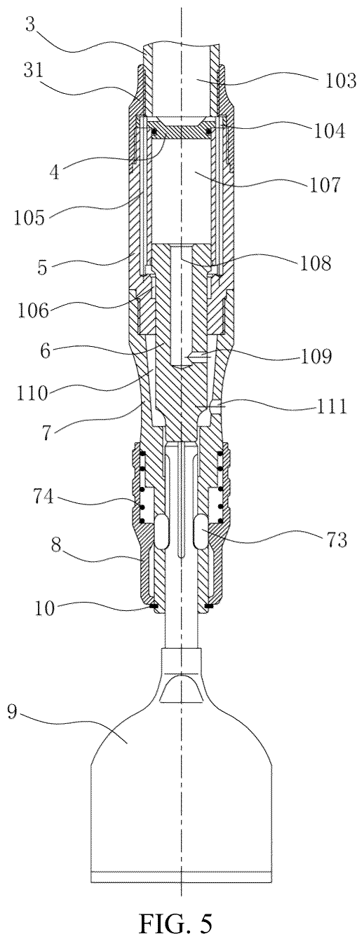

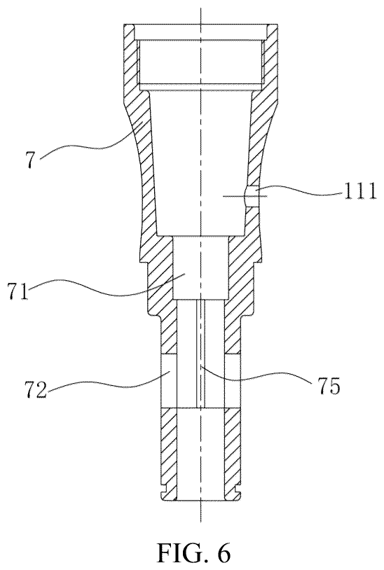

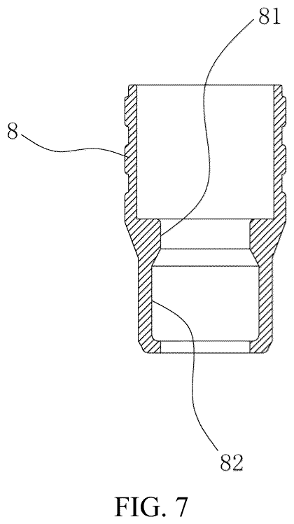

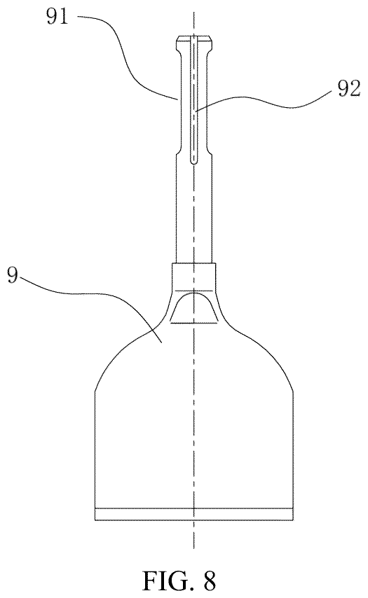

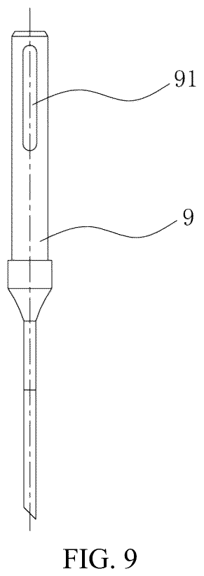

As shown in FIG. 1 to FIG. 9: 1. Handle, 11. Switch sleeve, 12. Handle body, 13. Inclined hole, 14. Vertical hole, 15. Horizontal hole, 151. Left hole, 152. Right hole, 153. Inner shoulder, 2. Air intake switch, 21. Push rod, 211. Valve pad, 212. Ball-headed end, 22. Pressing handle, 23. Valve spring, 24. Screw plug, 3. Coupling tube, 31. Coupling sleeve, 4. Air intake seat, 5. Hammer, 6. Cylinder, 7. Front member, 71. Mounting hole, 72. Side hole, 73. Ball-headed pin roller, 74. End sleeve compression spring, 75. Guide rib, 8. End sleeve, 81. Protrusion, 82. Recess, 9. Spade head, 91. Slot, 92. Guide slot, 10. Shaft retaining ring, 101. Air intake connector, 102. Connecting cavity, 103. Air intake cavity, 104. Air inlet, 105. Cylinder channel, 106. Lower cavity, 107. Upper cavity, 108. Blind air outlet, 109. Air outlet, 110. Air outlet cavity, 111. Vent hole.

As shown in FIG. 1, a straight-handle valveless pressurized pneumatic spade relates to a pneumatic impact tool that uses an inputted high-pressure gas to push a hammer 5 to reciprocate axially through a specially designed air intake system and then continuously strike a spade head 9 to operate. The pneumatic spade may be equipped with various spade heads 9 based on actual use needs. The spade heads are used in an impact mode for various tasks in gardening and agricultural tasks such as land excavation, trenching, digging, planting, greening, and harvesting and growing of trees and some crops, or used for decoration tasks such as wall shoveling, floor shoveling, and shoveling of excess glue and asphalt during decoration, or used for small-scale concrete breaking, foundation tamping, slotting, hole drilling, and perforation in municipal engineering, or used for sand removal of various castings and shoveling, cutting, and trimming of a surface of a metal material.

A structure of the pneumatic spade is mainly composed of a handle 1, a coupling tube 3, a cylinder 6, a front member 7, and the like that are successively connected.

The handle 1 is composed of a switch sleeve 11 mounted to an upper portion of the coupling tube 3 and a handle body 12 mounted to an upper portion of the switch sleeve. The switch sleeve 11, the handle body 12, the coupling tube 3, the cylinder 6, and the front member 7 are all on the same shaft axis, so that the handle 1 forms a straight handle.

A connecting cavity 102 is arranged in the switch sleeve 11. A horizontal hole 15, an inclined hole 13 provided above the horizontal hole, and a vertical hole 14 respectively in communication with the horizontal hole 15 and the connecting cavity 102 are provided in the handle body 12. An air intake connector 101 hermetically inserted and directly communicating with the horizontal hole 15 is provided in the inclined hole 13, and may be configured to connect to an external air intake tube to input a high-pressure gas. In other words, a top portion of the handle body 12 is provided with the air intake connector 101, a middle portion of the horizontal hole 15 is provided with an inner shoulder 153, and the horizontal hole is divided into a left hole 151 and a right hole 152 by the inner shoulder.

An air intake switch 2 is arranged in the handle body 12, and the air intake switch is configured to enable and disable communication between the air intake connector 101 and the connecting cavity 102. The air intake switch 2 includes a push rod 21 movably and hermetically arranged in the horizontal hole 15. Specifically, the push rod is movably and hermetically arranged in the left hole 151, and an inner end of the push rod 21 extends into the right hole 152 and is provided with a valve pad 211. A valve spring 23 that elastically pushes the push rod 21 outward is further arranged in the right hole 152. In this embodiment, the right hole 152 extends through the handle body 12 to the right, so that the valve spring 23 can be mounted, and then an extending portion is sealed through a screw plug 24. In this way, an outer end of the push rod 21 may be elastically pushed outward, that is, pushed to the left, and extend out of the horizontal hole 15 and contact the pressing handle 22. An upper end of the pressing handle is hinged to the handle body 12 through a hinge pin. In this way, only by pressing the push rod 21 to move inward through the pressing handle 22 can the valve pad 211 be driven to be disengaged from the inner shoulder 153 to open the horizontal hole 15, or a pressing force on the pressing handle 22 is released. The push rod 21 is elastically pushed to move outward to its original position, and therefore drives the valve pad 211 to contact the inner shoulder 153 to close the horizontal hole 15. However, an outer end of the push rod 21 is arranged as a ball-headed end 212 to contact the pressing handle 22 to facilitate a pressing operation of the pressing handle.

Apparently, such a straight handle has a simpler appearance, so as to facilitate assembling of the air intake switch 2, and a mounting structure is also more compact, thereby avoiding a risk of air leakage. In addition, the simple appearance reduces a packaging volume and facilitates transportation and storage.

The coupling tube 3 is a hollow light aluminum alloy round tube that is vertically arranged. Therefore, an air intake cavity 103 is formed in the coupling tube 3. The coupling tube 3 and the cylinder 6 are integrally connected through a coupling sleeve 31, and an upper end of the front member 7 is directly threadedly connected to a lower end of the cylinder 6. The cylinder 6 and the front member 7 both adopt an axial pass-through design. An upper end of the cylinder 6 is provided with an air intake seat 4 hermetically mounted through a seal ring. A hammer 5 is arranged in the cylinder 6 and the front member 7. An upper end of the hammer axially reciprocates and is hermetically inserted into the cylinder 6. A lower end of the hammer is located in the front member 7. Therefore, an upper cavity 107 is exactly formed in the cylinder 6 between the air intake seat 4 and the upper end of the hammer 5, and a lower cavity 106 is formed between an outer wall of the hammer 5 and an inner wall of the cylinder 6. An air outlet cavity 110 is formed between the hammer 5 and the front member 7. A side of the front member 7 is further provided with a vent hole 111 respectively in communication with the air outlet cavity 110 and an external atmosphere. 3 vent holes may be provided, and are circumferentially evenly distributed on an outer surface of the front member 7.

In addition, a plurality of air inlets 104 are provided on the air intake seat 4. A quantity of air inlets may be designed based on a dimension of the air intake seat 4. A cylinder air channel 105 in communication with the lower cavity 106 is arranged in the cylinder 6. The arrangement position of the cylinder air channel is correspondingly in communication with the arrangement position of the air inlet 104. Therefore, the air intake cavity 103 in the coupling tube 3 may be brought into communication with the cylinder air channel 105 through the plurality of air inlets 104 on the air intake seat 4.

Moreover, a blind air outlet 108 extending along a shaft axis thereof is provided in the hammer 5. The blind air outlet is directly brought into communication with the upper cavity 107. A side of the hammer 5 is provided with an air outlet 109 in communication with the blind air outlet 108. 3 air outlets are provided, and are circumferentially evenly distributed on an outer surface of the hammer 5 with the blind air outlet 108 as a center.

The front member 7 adopts the axial pass-through design, and therefore a mounting hole 71 is formed therein. An upper end of the spade head 9 may be inserted into the mounting hole 71 or disengaged from the mounting hole 71. An inner wall of the mounting hole and an outer surface of the upper end of the spade head are provided with a guide rib 75 and a guide slot 92 for guiding movement of the spade head 9, so that the mounted spade head 9 can only axially reciprocate and cannot radially rotate. However, a plurality of evenly distributed circumferential slots 91 are further provided on an outer circumferential surface of the upper end of the spade head 9. A side of the front member 7 is provided with a side hole 72 communicating with the mounting hole 71, and a ball-headed pin roller 73 is arranged in the side hole. A lower portion of the front member 7 is provided with an end sleeve 8 that is movably sleeved and an end sleeve compression spring 74. An inner wall of the end sleeve 8 is provided with a protrusion 81 and a recess 82. The end sleeve compression spring 74 always elastically pushes the end sleeve 8 downward in a normal state, and then drives the protrusion 81 of the end sleeve to push the ball-headed pin roller 73, and a shaft retaining ring 10 for fixing a lower end position of the end sleeve 8 is arranged on the front member 7, to prevent the end sleeve from being pushed downward by the end sleeve compression spring 74 and disengaged from the lower portion of the front member 7.

A mounting process of the spade head 9 is as follows. First, the end sleeve 8 is driven by an external force to move upward against a pushing electric force of the end sleeve compression spring 74, and the recess 82 is caused to exactly face the ball-headed pin roller 73. In this case, the ball-headed pin roller can be retracted into the side hole 72, and the upper end of the spade head 9 can be inserted into the mounting hole 71. Then the external force on the end sleeve 8 is released, and the end sleeve compression spring 74 pushes the end sleeve 8 to move downward and pushes the ball-headed pin roller 73 through the protrusion 81. The ball-headed pin rollers protrude out of the side holes 72 to be fitted into the slots 91 on the outer circumferential surface of the spade head 9. In this case, the spade head 9 is not disengaged from the mounting hole 71.

A length dimension of the slot 91 needs to be greater than a diameter of the side hole 72, so that the ball-headed pin roller 73 has a stroke for axially reciprocally moving up and down in the slot 91. In a case that the spade head 9 is not disengaged, the hammer 5 can continuously strike the spade head 9 to generate high-frequency movement of extending and retraction, thereby achieving the purpose of operation.

It may be learned from the foregoing description of the structure of the pneumatic spade that the air intake system thereof is mainly composed of the air intake connector 101, the inclined hole 13, the horizontal hole 15, the vertical hole 14, the connecting cavity 102, the air intake cavity 103, the air inlet 104, the cylinder air channel 105, the upper cavity 107, the lower cavity 106, the blind air outlet 108, the air outlet 109, the air outlet cavity 110, and the vent hole 111. The operation process is as follows.

The hammer 5 of the air intake system in a normal state is located at a lower end. An operator turns on the air intake switch 2 through the pressing handle 22, and a high-pressure gas is inputted from the handle 1 and then enters the lower cavity 106 through the air intake cavity 103, the air inlet 104, and the cylinder air channel 105 in sequence. In this case, the upper cavity 107, the blind air outlet 108, the air outlet 109, the air outlet cavity 110, and the vent hole 111 are in communication with each other. Therefore, the hammer 5 can move upward quickly when pushed by the high-pressure gas.

Next, the upward movement of the hammer 5 drives the air outlet 109 into the cylinder 6 to be enclosed. That is, the upper cavity 107 and the blind air outlet 108 cannot communicate with the air outlet cavity 110 and the vent hole 111 through the air outlet 109, but the high-pressure gas continues to enter the lower cavity 106 at this point. Therefore, vacuum compression is generated in the upper cavity 107 and the blind air outlet 108 with the upward movement of the hammer 5, and a high-pressure expansion gas is formed.

Then the hammer 5 continues to move upward, and drives the air outlet 109 to communicate with the lower cavity 106. In this case, the lower cavity 106, the air outlet 109, the blind air outlet 108, and the upper cavity 107 instantaneously communicate, the continuously inputted high-pressure gas instantaneously enters the upper cavity 107 and the blind air outlet 108, and the high-pressure expansion gas instantly intervenes in an external high-pressure gas. Therefore, a high-pressure gas explosion is formed in the upper cavity 107, and impact energy several times higher than that of the hammer 5 directly pushed by a compressed gas is generated. The driven hammer 5 can then move downward quickly to strike the spade head 9, and the spade head is directed toward an operating object, thereby completing a round of intake operation of the air intake system.

Therefore, the high-pressure gas that continues to enter repeats an air intake route of the foregoing air intake system again, so as to drive the hammer 5 to axially reciprocate and continuously strike the spade head 9 to operate. In this way, the hammer 5 not only functions as an impact hammer, but also serves as an air distribution valve in a conventional pneumatic spade structure.

The pneumatic spade using the foregoing air intake system pushes the hammer to operate through pressurization, thereby reducing gas consumption, avoiding a waste of high-pressure gas, and increasing the impact energy.

Moreover, an air cushion always exists in the upper cavity 107. Therefore, the axial upward movement of the hammer 5 does not strike the air intake seat 4, thereby preventing the hammer 5 from damaging parts, reducing a recoil vibration force when the pneumatic spade is used, and improving stability and comfort of the operation performance.

In addition, the pneumatic spade having the foregoing air intake system can further effectively avoid occurrence of the hammer 5 striking without load. When the spade head is forgotten to be mounted or the spade head is stuck in the operating object during the operation, the operator attempts to pull the spade head outward to pull out the spade head 9 while keeping the air intake switch 2 open, to strike the spade head without load. In this case, if the hammer 5 continues to impact and do work, an inner step of the front member 7 is hit, thus damaging two main components of the pneumatic spade and causing the pneumatic spade to be unusable in severe cases. To prevent this case from damaging the pneumatic spade, as long as a front end of the hammer 5 does not touch the spade head 9 in the disclosure, once the hammer continues to move forward to a lowest position, the lower cavity 106 and the air intake channel 101 is separated, and the upper cavity 107 is brought into communication with the air intake channel 101. The compressed air is directly discharged from the upper cavity 107 to the air outlet cavity 110 through the blind air outlet 108 and the air outlet 109 of the hammer 5, and then discharged through the vent hole 111, and then the hammer 5 stops moving. In this way, a problem of damage due to the striking without load is resolved technically.

In the disclosure, the overall material is mainly a light aluminum alloy and engineering plastics, so that the machine has a light weight, a clean appearance, and a good operation feel.

The foregoing descriptions are only specific embodiments of the disclosure. A person skilled in the art should understand that any structural design equivalent to this embodiment shall fall within the protection scope of the disclosure.

What is claimed is:

1. A straight-handle valveless pressurized pneumatic spade, comprising a coupling tube (3), a handle (1) mounted to an upper portion of the coupling tube, a cylinder (6) mounted to a lower portion of the coupling tube, and a front member (7) mounted to a lower portion of the cylinder, wherein a hammer (5) is arranged inside the cylinder (6) and the front member (7), an upper end of the hammer axially reciprocates and is hermetically inserted into the cylinder (6), a lower portion of the front member (7) is provided with a spade head (9) that is axially movable and inserted, the handle (1) is composed of a switch sleeve (11) mounted to the upper portion of the coupling tube (3) and a handle body (12) mounted to an upper portion of the switch sleeve, the handle body (12), the switch sleeve (11), the coupling tube (3), the cylinder (6), and the front member (7) are all on a same shaft axis, so that the handle (1) forms a straight handle, a connecting cavity (102) is arranged in the switch sleeve (11), a top portion of the handle body (12) is provided with an air intake connector (101), an air intake switch (2) is arranged in the handle body (12), and the air intake switch (2) is configured to enable and disable communication between the air intake connector (101) and the connecting cavity (102).

2. The straight-handle valveless pressurized pneumatic spade according to claim 1, wherein a horizontal hole (15), an inclined hole (13) arranged above the horizontal hole, and a vertical hole (14) respectively in communication with the horizontal hole (15) and the connecting cavity (102) are provided in the handle body (12), and the air intake connector (101) is hermetically inserted into the inclined hole (13) and directly brought into communication with the horizontal hole (15).

3. The straight-handle valveless pressurized pneumatic spade according to claim 2, wherein the air intake switch (2) comprises a push rod (21) movably and hermetically arranged in the horizontal hole (15), an outer end of the push rod is elastically pushed outward and extends out of the horizontal hole (15) to contact a pressing handle (22), an inner end of the push rod (21) is provided with a valve pad (211), the pressing handle (22) presses the push rod (21) to move inward and drives the valve pad (211) to open the horizontal hole (15), or the push rod (21) is elastically pushed to move outward to its original position, and therefore drives the valve pad (211) to close the horizontal hole (15).

4. The straight-handle valveless pressurized pneumatic spade according to claim 3, wherein an inner shoulder (153) is arranged in a middle portion of the horizontal hole (15), the horizontal hole (15) is divided into a left hole (151) and a right hole (152) by the inner shoulder, the push rod (21) is movably and hermetically arranged in the left hole (151), an inner end of the push rod (21) extends into the right hole (152) and is provided with the valve pad (211), a valve spring (23) that elastically pushes the push rod (21) outward is arranged in the right hole (152), and the push rod (21) moves axially inward and outward and drives the valve pad (211) to be disengaged from the inner shoulder (153) to open the horizontal hole (15) or to contact the inner shoulder (153) to close the horizontal hole (15).

5. The straight-handle valveless pressurized pneumatic spade according to claim 1, wherein an upper portion of the cylinder (6) is provided with an air intake seat (4) that is hermetically mounted, an upper cavity (107) is formed in the cylinder (6) between the air intake seat and the upper end of the hammer (5), a lower cavity (106) is formed between an outer wall of the hammer (5) and an inner wall of the cylinder (6), an air outlet cavity (110) is formed between the hammer (5) and the front member (7), a cylinder air channel (105) in communication with the lower cavity (106) is provided in the cylinder (6), an air inlet (104) respectively in communication with an air intake cavity (103) in the coupling tube and the cylinder air channel (105) is provided on the air intake seat (4), a blind air outlet (108) in communication with the upper cavity (107) is provided in the hammer (5), a side of the hammer (5) is provided with an air outlet (109) in communication with the blind air outlet (108), the air outlet is brought into communication with the air outlet cavity (110) or the lower cavity (106) through the axial reciprocation of the hammer (5), and a side of the front member (7) is provided with a vent hole (111) respectively in communication with the air outlet cavity (110) and an external atmosphere.

6. The straight-handle valveless pressurized pneumatic spade according to claim 1, wherein an interconnecting coupling sleeve (31) is arranged between the coupling tube (3) and the cylinder (6), and an upper end of the front member (7) is threadedly connected to a lower end of the cylinder (6).

7. The straight-handle valveless pressurized pneumatic spade according to claim 1, wherein an axial pass-through mounting hole (71) is provided in the front member (7), a side of the front member is provided with a side hole (72) in communication with the mounting hole, a ball-headed pin roller (73) is arranged in the side hole, the lower portion of the front member (7) is provided with an end sleeve (8) that is movably sleeved, an inner wall of the end sleeve is provided with a protrusion (81) and a recess (82), the end sleeve (8) moves upward to drive the recess (82) to exactly face the ball-headed pin roller (73), the ball-headed pin roller retracts into the side hole (72), an upper end of the spade head (9) is inserted into the mounting hole (71) or disengaged from the mounting hole (71), the end sleeve (8) moves downward to drive the protrusion (81) to push the ball-headed pin roller (73), and the ball-headed pin roller protrudes out of the side hole (72) to lock the upper end of the spade head (9).

8. The straight-handle valveless pressurized pneumatic spade according to claim 7, wherein a plurality of evenly distributed circumferential slots (91) are provided on an outer circumferential surface of the upper end of the spade head (9), and the ball-headed pin roller (73) protrudes out of the side hole (72) to be fitted into each of the slots (91) to lock the upper end of the spade head (9).

9. The straight-handle valveless pressurized pneumatic spade according to claim 8, wherein the slots (91) are waist-shaped slots extending in an axial direction, a length dimension of each of the slots (91) needs to be greater than a diameter of the side hole (72), and the ball-headed pin roller (73) needs to have a stroke for axially reciprocally moving up and down in the slot (91).

10. The straight-handle valveless pressurized pneumatic spade according to claim 9, wherein the lower portion of the front member (7) is provided with an end sleeve compression spring (74) that is sleeved, the end sleeve compression spring elastically pushes the end sleeve (8) downward and then drives the protrusion (81) to push the ball-headed pin roller (73), and a shaft retaining ring (10) for fixing a lower end position of the end sleeve (8) is arranged on the front member (7).
